(19) United States
(12) Patent Application Publication
(10) Pub. No.: US 2025/0337953 A1
(43) Pub. Date: Oct. 30, 2025

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Yingzhan XU, Beijing (CN); Wenyi WANG, Beijing (CN); Kai ZHANG, Los Angeles, CA (US); Li ZHANG, Los Angeles, CA (US)

(21) Appl. No.: 19/260,153

(22) Filed: Jul. 3, 2025

Related U.S. Application Data
(63) Continuation of application No. PCT/CN2024/070928, filed on Jan. 5, 2024.

(30) Foreign Application Priority Data
Jan. 6, 2023 (WO) PCT/CN2023/070905

(51) Int. Cl. H04N 19/597; H04N 19/159; H04N 19/169; H04N 19/96

(52) U.S. Cl. CPC H04N 19/597; H04N 19/159; H04N 19/1883; H04N 19/96

(57) ABSTRACT

Embodiments of the present disclosure provide a solution for point cloud coding. A method for point cloud coding is proposed. The method comprises: performing a conversion between a current point cloud (PC) sample of a point cloud sequence and a bitstream of the point cloud sequence, wherein an attribute inter prediction scheme is enabled for a set of levels in a first tree structure for spatial partition of the current PC sample, and the bitstream comprises a first indication indicating the number of the set of levels.

### CROSS REFERENCE TO RELATED APPLICATIONS

This application is a continuation of International Application No. PCT/CN2024/070928, filed on Jan. 5, 2024, which claims the benefit of International Application No. PCT/CN2023/070905, filed on Jan. 6, 2023. The entire contents of these applications are hereby incorporated by reference in their entireties.

### FIELDS

Embodiments of the present disclosure relates generally to point cloud coding techniques, and more particularly, to attribute inter prediction.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: performing a conversion between a current point cloud (PC) sample of a point cloud sequence and a bitstream of the point cloud sequence, wherein an attribute inter prediction scheme is enabled for a set of levels in a first tree structure for spatial partition of the current PC sample, and the bitstream comprises a first indication indicating the number of the set of levels.

Based on the method in accordance with the first aspect of the present disclosure, the number of tree levels for which the attribute inter prediction scheme is enabled is indicated in the bitstream. Compared with the conventional solution, the proposed method can advantageously support an adaptive configuration of the number of tree levels for which the attribute inter prediction scheme is enabled, and thus the coding efficiency can be improved.

In a second aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by an apparatus for point cloud coding. The method comprises: performing a conversion between a current point cloud (PC) sample of the point cloud sequence and the bitstream, wherein an attribute inter prediction scheme is enabled for a set of levels in a first tree structure for spatial partition of the current PC sample, and the bitstream comprises a first indication indicating the number of the set of levels.

In a fifth aspect, a method for storing a bitstream of a point cloud sequence is proposed. The method comprises: performing a conversion between a current point cloud (PC) sample of the point cloud sequence and the bitstream, wherein an attribute inter prediction scheme is enabled for a set of levels in a first tree structure for spatial partition of the current PC sample, and the bitstream comprises a first indication indicating the number of the set of levels; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates parent-level nodes for each sub-node of transform unit node;

FIG. 5 illustrates a flowchart for an example process of attribute inter prediction in accordance with embodiments of the present disclosure;

FIG. 6 illustrates a flowchart of a method for point cloud coding in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

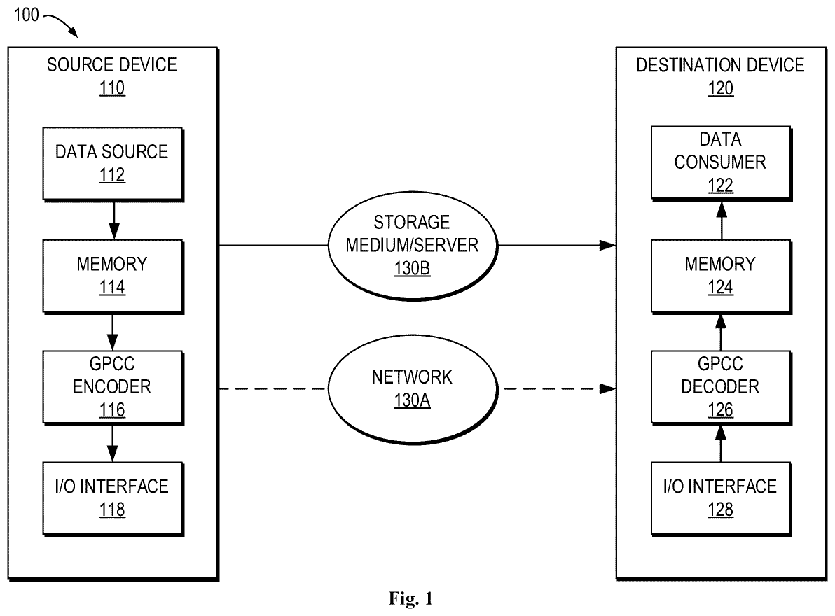

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like.

In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

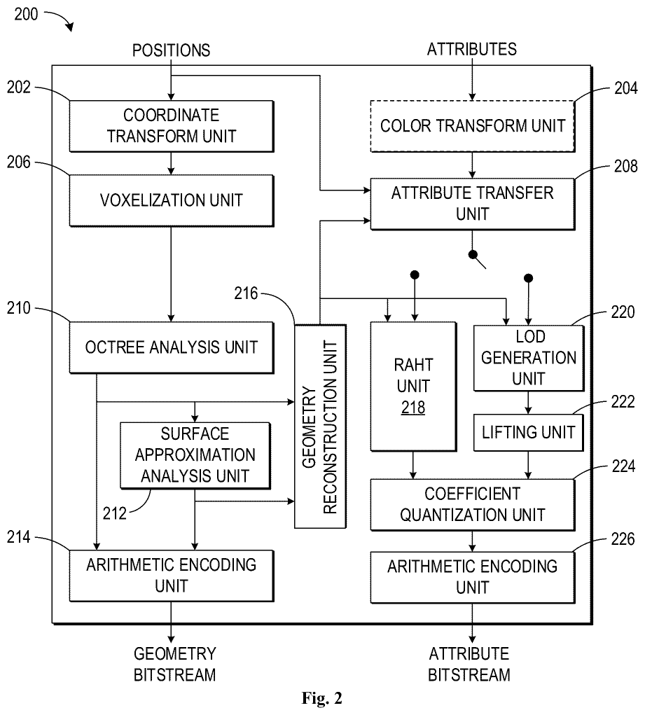

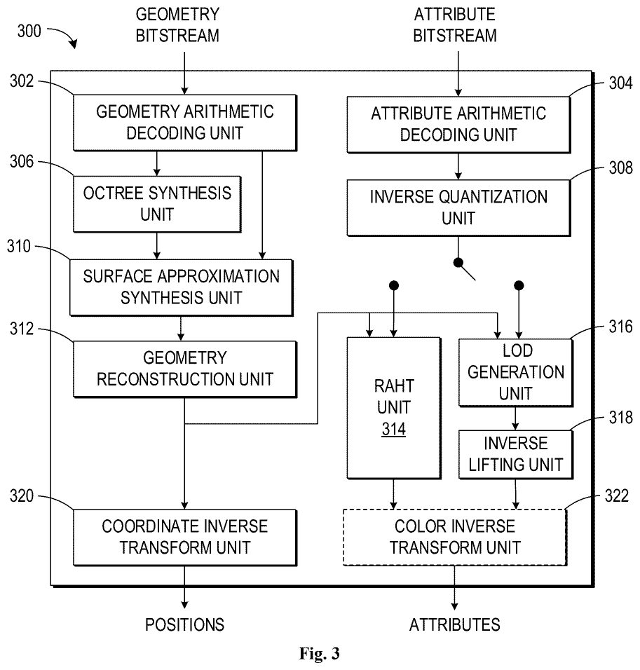

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is related to point cloud attribute inter prediction in region-adaptive hierarchical transform. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
RAHT Region-Adaptive Hierarchical Transform

### 3. Introduction

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Region-Adaptive Hierarchical Transform

In G-PCC, one of important point cloud attribute coding tools is RAHT. It is a transform that uses the attributes associated with a node in a lower level of the octree to predict the attributes of the nodes in the next level. It assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level l be g_{l,x,y,z}, for x, y, z integers. g_{l,x,y,z} was obtained by grouping g_{1+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{1-1,x,y,z}=g_{1,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, say g_{l,2x,y,z} and g_{l,2x+1,y,z}, with their respective weights, ω_{1,2x,y,z} and ω_{l,2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

where ω₁=ω_{l,2x,y,z} and ω₂=ω_{l,2x+1,y,z} and

$${T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , x} + {ω}_{l , 2 x + 1 , y , z} .$$

In the last stage, the tree root, the remaining two voxels g_{1,0,0,0} and g_{1,1,0,0} are transformed into the final two coefficients as:

$$where {g}_{DC} = {g}_{0 , 0 , 0 , 0} . [ \begin{matrix}{g}_{DC} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {h}_{1 , 1 , 0 , 0}\end{matrix} ] ,$$

3.3 Upsampled transform domain prediction in RAHT

The transform domain prediction is introduced to improve coding efficiency on RAHT. It is formed of two parts. Firstly, the RAHT tree traversal is changed to be descent based from the previous ascent approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root. Secondly, for each sub-node of transform unit, a corresponding predicted sub-node is produced by upsampling the previous transform level. Actually, only sub-node that contains at last one point will produce a corresponding predicted sub-node. The transform unit that contains 2×2×2 predicted sub-nodes is transformed and subtracted from the transformed attributes at the encoder side.

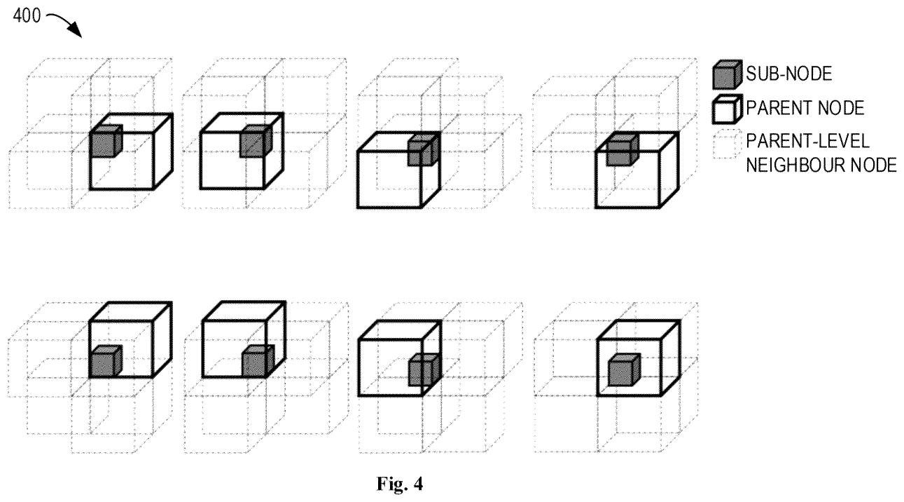

Each sub-node of transform unit node is predicted by 7 parent-level nodes where 3 coline parent-level neighbour nodes, 3 coplane parent-level neighbour nodes and 1 parent node. Coplane and coline neighbours are the neighbours that share a face and an edge with current transform unit node, respectively. FIG. 4 is a schematic diagram 400 illustrating 7 parent-level nodes for each sub-node of transform unit node.

The attribute αᵤₚ of each sub-node is predicted depending on the distance between it and its parent-level node as follows.

$${a}_{up} = \sum {ω}_{k} {a}_{k} / \sum {ω}_{k}$$

αₖ is the attribute of its one parent-level node and ωₖ is weight depending on the distance. In G-PCC, ωₚₐᵣₑₙₜ: ω_{coplane}: ω_{coline}=4:2:1.

For AC coefficient, the prediction residual will be signalled.

For DC coefficient, the coefficients are inherited from the previous level, which means that the DC coefficient is signalled without prediction.

### 3.4 Attribute Inter Prediction in RAHT

The attribute inter prediction in RAHT was proposed. It is proposed to apply inter-prediction to DC and AC coefficients in RAHT. The same octree decomposition is performed on the current frame and the reference frame. For the first 5 layers, the same scan of the octree is performed on the two frames. Before performing the octree scan backwards, a point-to-point matching process needs to be performed to ensure that the node of the reference frame can establish a corresponding one-to-one relationship with the node of the current frame. For each point in the reference frame, it will be matched to one point in the current frame in a “upper matching” method. The Morton value of the matched point is the smallest Morton value greater than the Morton value of the current point.

For DC coefficients, the residual between the DC coefficient for the root node of the current frame and the DC coefficient for the root node of the reference frame is calculated as:

$${DC}_{residual} = {DC}_{current} - {DC}_{reference} .$$

The DC_{residual} is signaled to the decoder in place of DC_{current}.

For each node in the first 5 layers, the average attribute of the node in the same octree location in the reference frame is calculated as Attr_{predicted_inter} and the corresponding AC coefficients are calculated as AC_{predicted_inter}.

For AC coefficients, the prediction residual is signalled as:

$$\begin{matrix}{AC}_{residual} = {AC}_{current} - {AC}_{predicted} , \\ {AC}_{predicted} = {AC}_{predicted\_inter} ? {AC}_{predicted\_inter} : {AC}_{predicted\_intra} .\end{matrix}$$

If the AC_{predicted_inter} is equal to zero, the AC_{predicted_intra} is applied as the original transform domain prediction.

### 4. Problems

The existing designs for point cloud attribute inter prediction in RAHT have the following problems:
1. In current design, the number of layers to enable attribute inter prediction in RAHT is fixed (such as 5). However, applying different number of layers for different point cloud sequences can provide better compression performance. For example, a higher number is applied to the sequence with high inter frame redundant and a lower number is applied to the sequence with low inter frame redundant.
2. In current design, a point-to-point “up-matching” process needs to be performed to ensure that the node of the reference frame can establish a corresponding one-to-one relationship with the node of the current frame. However, the matching result is not accurate enough, that is, the Morton value of the current point and the matched point may be too different. This will lead to a large difference in the geometric information and attribute information between the points contained in the reference frame node and the points contained in the current frame node, which will affect the prediction performance.
3. In current design, the inter prediction result is used to replace the intra prediction result. However, the intra prediction result may be closer to the original value than the inter prediction result.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner.

1) It is proposed to perform the attribute inter prediction in RAHT on a set of layers of the octree scan.
a. In one example, there may be multiple layers for the octree scan. Each layer corresponds to one depth of the octree scan.
b. In one example, the set is the first N layers of the octree scan. N may be one non-negative integer.
   i. In one example, N may be one pre-defined value.
   ii. In one example, N may be derived at the encoder.
   iii. In one example, N may be derived at the decoder.
   iv. In one example, N may be signalled to the decoder.
      1. In one example, N may be coded with fixed-length coding, unary coding, truncated unary coding, etc. al.
      2. In one example, N may be coding in a predictive way.
c. In one example, the set is the last N layers of the octree scan. N may be one non-negative integer.
   i. In one example, N may be one pre-defined value.
   ii. In one example, N may be derived at the encoder.
   iii. In one example, N may be derived at the decoder.
   iv. In one example, N may be signalled to the decoder.
      1. In one example, N may be coded with fixed-length coding, unary coding, truncated unary coding, etc. al.
      2. In one example, N may be coding in a predictive way.
d. In one example, the set may be a list of the layer indications.
   i. In one example, there may be at least one indication for each layer of octree scan.
      1. In one example, the indication may be the depth value of the layer.
   ii. In one example, the list may be pre-defined.
   iii. In one example, the list may be derived at the encoder.
   iv. In one example, the list may be derived at the decoder.
   v. In one example, the list may be signalled to the decoder.
      1. In one example, the list may be coded with fixed-length coding, unary coding, truncated unary coding, etc. al.
      2. In one example, the list may be coding in a predictive way.

2) It is proposed to perform the same octree scan backwards on the reference frame and the current frame to perform attribute inter prediction in RAHT.
a. In one example, one backward octree scan is determined by the geometry information of the current frame. The backward octree scan is performed from the leaf node level to the root node level.
b. In one example, the determined octree scan may be performed on the current frame and the reference frame to perform attribute inter prediction.
   i. In one example, each node A in the octree of the current frame may correspond to one node B in the octree of the reference frame.
      1. In one example, node A and node B may share a same octree location.
      2. Alternatively, node A and node B may share a same Morton code value to indication the octree location.
   ii. In one example, the attribute information of points in node B may be used to predict the attribute information of node A.

3) It is proposed to match points in the reference frame to points in the current frame based on the geometry information before performing RAHT and attribute inter prediction following the octree scan backwards.
a. In one example, the point-to-point match process may be performed for all points in the reference frame.
b. In one example, the point-to-point match process may be performed for part points in the reference frame.
   i. In one example, if the geometry information of one point in the reference frame is higher than one lower threshold thA and lower than one higher threshold thB, the point-to-point match process may be applied to the point.
      1. In one example, the geometry information may be the Morton code value.
      2. In one example, thA may be derived based on the smallest geometry information of all points in the current frame.
      3. In one example, thB may be derived based on the biggest geometry information of all points in the current frame.
   ii. In one example, if the point distance from one point in the reference frame to point A is lower than one threshold N, the point-to-point match process may be applied to the point.
      1. In one example, point A may be the point in the reference frame with a biggest Morton code value that is smaller than the smallest Morton code value of all points in the current frame.
      2. In one example, point A may be the point in the reference frame with a smallest Morton code value that is bigger than the biggest Morton code value of all points in the current frame.
      3. In one example, the point distance from point B to point C may the number of points between point B and point C in Morton code value order.
      4. In one example, N may be one pre-defined value.
      5. In one example, N may be signalled to the decoder.
         a. In one example, N may be coded with fixed-length coding, unary coding, truncated unary coding, etc. al.
         b. In one example, N may be coding in a predictive way.
c. In one example, each point to be performed match process may be matched to one point in the current frame based on the geometry information.
   i. In one example, the matching may be based on the geometry distance.
      1. In one example, the point may be matched to one point with the smallest geometry distance.
      2. In one example, the geometry distance may be the difference of the geometry information of the points.
         a. In one example, the geometry information may be represented by the Morton code value.

4) It is proposed to generate the prediction result based on the inter prediction result and intra prediction result.
a. In one example, the prediction result may be the average of the inter prediction result and the intra prediction result.
b. In one example, the prediction result may be the weighted average of the inter prediction result and the intra prediction result.
   i. In one example, the weight values may be pre-defined.
   ii. In one example, the weight values may be derived at the encoder.
   iii. In one example, the weight values may be derived at the decoder.
   iv. In one example, the weight values may be signalled to the decoder.
      1. In one example, the weight values may be coded with fixed-length coding, unary coding, truncated unary coding, etc. al.
      2. In one example, the weight values may be coding in a predictive way.
c. In one example, the prediction result may be inter prediction result or intra prediction result.
   i. In one example, there may be one determining process to determine which result is used as the prediction result.
      1. In one example, the determining may be rate optimization selection.
      2. In one example, the determining may be distortion optimization selection.
         a. In one example, the distortion may be the prediction residual.
         b. In one example, the distortion may be the reconstructed residual.
      3. In one example, the determining may be rate-distortion optimization selection.
   ii. In one example, the result of determining may be derived at the encoder.
   iii. In one example, the result of determining may be derived at the decoder.
   iv. In one example, the result of determining may be signalled to the decoder.
      1. In one example, the result of determining values may be coded with fixed-length coding, unary coding, truncated unary coding, etc. al.
      2. In one example, the result of determining may be coding in a predictive way.
d. In one example, the prediction result may be generated by a linear or non-linear function of the inter prediction result and intra prediction result.

5) Whether to and/or how to apply a method disclosed above may be signaled from encoder to decoder in a bitstream/frame/tile/slice/octree/etc.

6) Whether to and/or how to apply the disclosed methods above may be dependent on coded information, such as dimensions, colour format, colour component, slice/picture type.

### 6. Embodiments

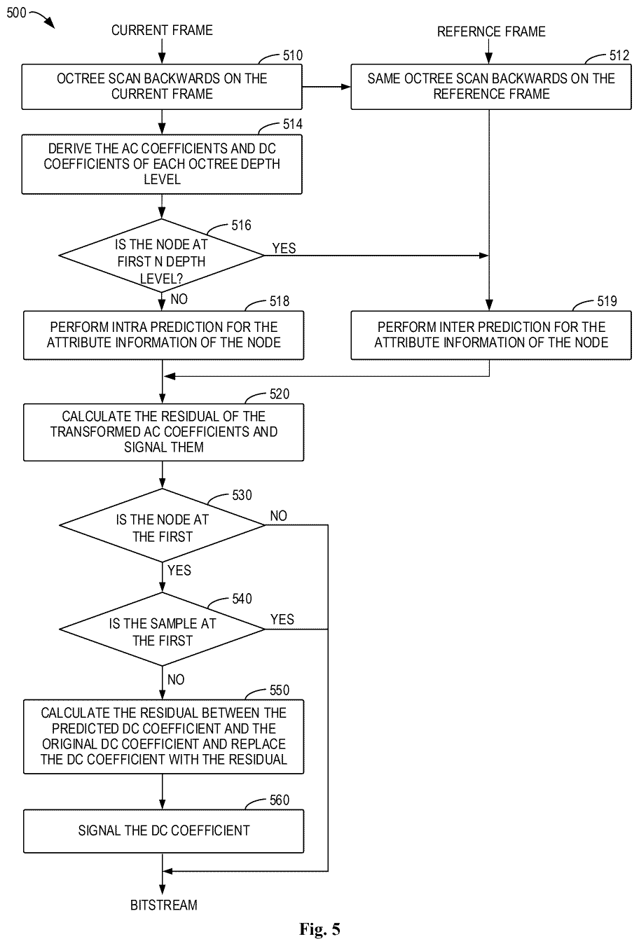

An example of the coding flow 500 for the improved inter prediction of AC and DC coefficients is depicted in FIG. 5. The attribute inter prediction for AC coefficients is enabled for the first N layers of the octree scan. As shown in FIG. 5, backward octree scan is performed on the current frame at block 510, and the same backward octree scan is performed on a reference frame of the current frame at block 512. At block 514, the AC coefficients and DC coefficients of each octree depth level are derived. At block 516, it is determined whether the node that is current being processed is at the first N depth level. N may be a non-negative integer, such as 4, 5, or the like. If the node is not at the first N depth level, the process proceeds to block 518 where intra prediction for the attribute information of the node is performed. If the node is at the first N depth level, the process proceeds to block 519 where inter prediction for the attribute information of the node is performed. At block 520, the residual of the transformed AC coefficients is calculated and the residual is signaled in the bitstream. At block 530, it is determined whether the current node is the first node of the current PC sample, i.e., a root node. If not, the processing of the DC coefficients of the current node is skipped. Otherwise, the process proceeds to block 540, where it is determined whether the current PC sample is the first PC sample of the point cloud sequence. If so, the processing of the DC coefficients of the current node is skipped, and the DC coefficients of the current node is coded into the bitstream directly. Otherwise, the process proceeds to block 550. At block 550, the residual between the predicted DC coefficient (i.e., a prediction of the DC coefficient of the current node) and the original DC coefficient (i.e., the DC coefficient of the current node) is calculated. Moreover, the DC coefficient of the current node is replaced with the calculated residual. By way of example, a set of bits originally allocated for the DC coefficient is filled with the calculated residual. At 560, the DC coefficient of the current node is signaled in the bitstream. As mentioned above, the set of bits originally allocated for the DC coefficient is filled with the calculated residual. Therefore, at 560, instead of the original DC coefficient, it is the calculated residual that is signaled in the bitstream.

More details of the embodiments of the present disclosure will be described below which are related to attribute inter prediction. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a picture, a slice, a sub-frame, a sub-picture, a tile, a segment, or any other suitable processing unit.

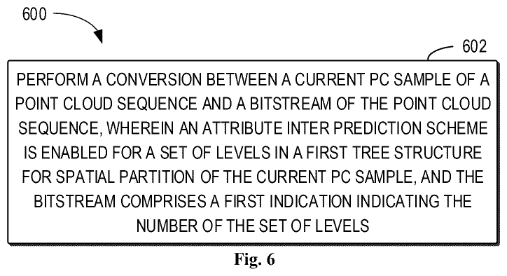

FIG. 6 illustrates a flowchart of a method 600 for point cloud coding in accordance with some embodiments of the present disclosure. At 602, a conversion between a current point cloud (PC) sample of a point cloud sequence and a bitstream of the point cloud sequence is performed. In some embodiments, the conversion may include encoding the current PC sample into the bitstream. Additionally or alternatively, the conversion may include decoding the current PC sample from the bitstream.

An attribute inter prediction scheme is enabled for a set of levels in a first tree structure (such as octree structure or the like) for spatial partition of the current PC sample. The bitstream comprises a first indication indicating the number of the set of levels. The number of the set of levels may be a non-negative integer, such as 0, 1, 3, 5, or the like. For example, if the attribute inter prediction scheme is enabled for a level, attribute information or coefficients for the attribute information of all nodes at the level may be determined based on the attribute inter prediction scheme. This will be described in detail below. As used herein, a level of a tree structure may also be referred to as a layer.

For example, the first tree structure may comprise a plurality of levels, and each of the plurality of levels corresponds to one depth in the first tree structure. In some embodiments, the set of levels may comprise the first N levels in the first tree structure that are counted starting from a root node of the first tree structure, where N is equal to the number of the set of levels. Alternatively, the set of levels may comprise the last N levels in the first tree structure that are counted starting from a leaf node of the first tree structure. In some further embodiments, the set of levels may be indicated by further indication(s) in the bitstream.

In view of the above, the number of tree levels for which the attribute inter prediction scheme is enabled is indicated in the bitstream. Compared with the conventional solution, the proposed method can advantageously support an adaptive configuration of the number of tree levels for which the attribute inter prediction scheme is enabled, and thus the coding efficiency can be improved.

In some embodiments, the number of the set of levels may be predetermined. Alternatively, the number of the set of levels may be determined at an encoder for performing the conversion. In some further embodiments, the number of the set of levels may be determined at a decoder for performing the conversion. In some still further embodiments, the number of the set of levels may be obtained at the decoder from the bitstream.

In some embodiments, the number of the set of levels may be coded with a fixed-length coding. In some further embodiments, the number of the set of levels may be coded with a unary coding. Alternatively, the number of the set of levels may be coded with a truncated unary coding. In some further embodiments, the number of the set of levels may be coded in a predictive way.

In some embodiments, the bitstream may further comprise a set of indications. Each level in the first tree structure may correspond to at least one indication in the set of indications, and the at least one indication may indicate whether the attribute inter prediction scheme is enabled for the corresponding level. By way of example, each level in the first tree structure may corresponds to a flag. If the flag is equal to a first value (such as 1 or the like), the attribute inter prediction scheme is enabled for the corresponding level, and the if flag is equal to a second value (such as 0 or the like), the attribute inter prediction scheme is disabled for the corresponding level.

Alternatively, the bitstream may further comprise a set of indications corresponding to the set of levels for which the attribute inter prediction scheme is enabled. Each of the set of indications may be a depth value of a corresponding level. By way of example, if the set of indications comprises {1, 2, 3}, the attribute inter prediction scheme may be enabled for levels corresponding to depth value 1, 2, and 3. This may also mean that the attribute inter prediction scheme is disabled for the other levels.

In some embodiments, the set of indications may be determined based on a rate optimization selection process. For example, whether to enable the attribute inter prediction scheme for all nodes at a level of the first tree structure may be determined based on a purpose of minimizing a bit rate for coding the nodes at level. In some alternative embodiments, the set of indications may be determined based on a distortion optimization selection process. For example, whether to enable the attribute inter prediction scheme for all nodes at a level of the first tree structure may be determined based on a purpose of minimizing the distortion. In some further embodiments, the set of indications may be determined based on a rate-distortion optimization selection process. For example, whether to enable the attribute inter prediction scheme for all nodes at a level of the first tree structure may be determined based on a purpose of minimizing a function of the distortion and the bit rate. In the above-described examples, the determination of whether the attribute inter prediction scheme is enabled is performed for each level. Alternatively, the determination of whether the attribute inter prediction scheme is enabled is performed for each node. This will be described in detail below.

In some embodiments, the set of indications may be predetermined. Alternatively, the set of indications may be determined at an encoder for performing the conversion. In some further embodiments, the set of indications may be determined at a decoder for performing the conversion. In some still further embodiments, the set of indications may be obtained at the decoder from the bitstream.

In some embodiments, the set of indications may be coded with a fixed-length coding. In some further embodiments, the set of indications may be coded with a unary coding. Alternatively, the set of indications may be coded with a truncated unary coding. In some still further embodiments, the set of indications may be coded in a predictive way.

In some embodiments, a target prediction associated with attribute information of a current node in the current PC sample may be determined based on a plurality of candidate predictions associated with the attribute information of the current node. A first candidate prediction in the plurality of candidate predictions may be determined based on the attribute inter prediction scheme, and a second candidate prediction in the plurality of candidate predictions may be determined based on an attribute intra prediction scheme. As used herein, a node of the first tree structure may represent a sub-volume of the three-dimensional space (or volume) containing the current PC sample.

In some embodiments, each of the target prediction and the plurality of candidate predictions may be a prediction of the attribute information of the current node. Alternatively, each of the target prediction and the plurality of candidate predictions may be a prediction of a coefficient for the attribute information of the current node. For example, the coefficient may be obtained by performing a region-adaptive hierarchical transform (RAHT) on the attribute information of the current node. By way of example, the coefficient may be an alternating current (AC) coefficient or a direct current (DC) coefficient.

In some embodiments, the current node may comprise the current PC sample and may be a root node of the first tree structure. Alternatively, the current node may comprise a part of the current PC sample and may be a non-root node of the first tree structure.

In some embodiments, the target prediction may be determined based on an average of the plurality of candidate predictions. Alternatively, the target prediction may be determined based on a weighted average of the plurality of candidate predictions.

In some embodiments, weight values for determining the weighted average may be predetermined. Alternatively, the weight values may be determined at an encoder for performing the conversion. In some further embodiments, the weight values may be determined at a decoder for performing the conversion. Alternatively, the weight values may be indicated in the bitstream.

In some embodiments, weight values for determining the weighted average may be coded with a fixed-length coding. Alternatively, weight values for determining the weighted average may be coded with a unary coding. In some further embodiments, the weight values may be coded with a truncated unary coding. In some still further embodiments, weight values for determining the weighted average may be coded in a predictive way.

In some embodiments, one of the plurality of candidate predictions may be selected to be the target prediction. For example, the target prediction may be selected from the plurality of candidate predictions based on a determining process. By way of example rather than limitation, the determining process may comprise a rate optimization selection process, a distortion optimization selection process, a rate-distortion optimization selection process, or the like. For example, a distortion used in the distortion optimization selection process or the rate-distortion optimization selection process may be determined based on a prediction residual or a reconstruction residual.

In some embodiments, the selection result may be indicated in the bitstream. For example, information regarding whether the inter prediction result or the intra prediction result is determined to be target prediction is indicated in the bitstream. For example, if it is determined at the encoder side that the intra prediction result is finally used as the target prediction for the current node, this information may be indicated in the bitstream. Then, at the decoder side, the intra prediction scheme may be applied to obtain the target prediction for the current node without applying the inter prediction scheme. In another example, if it is determined at the encoder side that the inter prediction result is finally used as the target prediction for the current node, this information may be indicated in the bitstream. Then, at the decoder side, the inter prediction scheme may be applied to obtain the target prediction for the current node without applying the intra prediction scheme. In some embodiments, a set of indications may be used to indicate such selection results.

As used herein, an inter prediction result may refer to a prediction result determined by using the attribute inter prediction scheme or a prediction result determined with the attribute inter prediction scheme being enabled for the current node. Similarly, an intra prediction result may refer to a prediction result determined by using an attribute intra prediction scheme or a prediction result determined with the attribute intra prediction scheme being enabled for the current node.

In some embodiments, a result of the determining process may be determined at an encoder for performing the conversion. In some further embodiments, the result of the determining process may be determined at a decoder for performing the conversion. Alternatively, the result of the determining process may be indicated in the bitstream.

In some embodiments, a result of the determining process may be coded with a fixed-length coding. Alternatively, a result of the determining process may be coded with a unary coding. In some further embodiments, a result of the determining process may be coded with a truncated unary coding. In some still further embodiments, a result of the determining process may be coded in a predictive way.

In some embodiments, the target prediction may be determined based on a linear function of the plurality of candidate predictions. For example, the target prediction may be determined by fusing the plurality of candidate predictions based on a liner function. Alternatively, the target prediction may be determined based on a non-linear function of the plurality of candidate predictions. For example, the target prediction may be determined by fusing the plurality of candidate predictions based on a non-liner function.

In some embodiments, for performing the attribute inter prediction scheme, a second tree structure for spatial partition of a reference PC sample for the current PC sample may be determined and the second tree structure is the same as the first tree structure. For example, a spatial partition scheme (such as backward octree scan or the like) for the current PC sample may be determined based on geometry information of the current PC sample, and the spatial partition scheme may be performed from a leaf node level in the first tree structure to a root node level in the first tree structure. In addition, the spatial partition scheme may be applied to the current PC sample and a reference PC sample for the current PC sample, so as to obtain the first and second tree structures.

In some embodiments, each node in a second tree structure for spatial partition of a reference PC sample for the current PC sample corresponds to a node in the first tree structure. In one example, a tree location (such as octree location) of a node in the second tree structure may be the same as a tree location of a corresponding node in the first tree structure. Alternatively, a Morton code value of a node in the second tree structure may be the same as a Morton code value of a corresponding node in the first tree structure.

In some embodiments, attribute information of a point in a node in the first tree structure may be determined based on attribute information of a point in a corresponding node in the second tree structure. For example, the attribute information of the point in the corresponding node in the second tree structure may be used as a prediction for the attribute information of the point in the node in the first tree structure.

In the above-described embodiments, both the inter prediction result and the intra prediction result are considered during determining the target prediction associated with attribute information of the current node. Thereby, the coding quality may be improved.

In some embodiments, a match process may be performed to match a point in a reference PC sample for the current PC sample to a point in the current PC sample. For example, the match process may be performed before an RAHT and the attribute inter prediction scheme being performed.

In some embodiments, the match process may be applied on all points in the reference PC sample. Alternatively, the match process may be applied on a part of points in the reference PC sample. In one example embodiment, if geometry metric of a first point in the reference PC sample is higher than a first threshold and lower than a second threshold, the match process may be applied on the first point. The second threshold is higher than the first threshold. By way of example rather than limitation, the geometry metric may comprise a Morton code value.

For example, the first threshold may be determined based on the smallest geometry metric among geometry metrics of all points in the current PC sample. Additionally or alternatively, the second threshold may be determined based on the largest geometry metric among geometry metrics of all points in the current PC sample.

In another example embodiment, if a distance metric from a first point in the reference PC sample to a second point different from the first point is lower than a third threshold, the match process may be applied on the first point. In one example, the second point may be a point in the reference PC sample that is of the largest geometry metric among geometry metrics of a first set of points in the reference PC sample, where the geometry metrics of the first set of points are smaller than the smallest geometry metric among geometry metrics of all points in the current PC sample. Alternatively, the second point may be a point in the reference PC sample that is of the smallest geometry metric among geometry metrics of a second set of points in the reference PC sample, where the geometry metrics of the second set of points may be larger than the largest geometry metric among geometry metrics of all points in the current PC sample. By way of example rather than limitation, the geometry metric may comprise Morton code value.

For example, the distance metric from the first point to the second point may be the number of points between the first point and the second point in Morton code value order.

In some embodiments, the third threshold may be predetermined. Additionally or alternatively, the third threshold may be indicated in the bitstream. For example, the third threshold may be coded with a fixed-length coding, a unary coding, or a truncated unary coding. Alternatively, the third threshold may be coded in a predictive way.

In some embodiments, in the match process, a first point in the reference PC sample may be matched to a third point in the current PC sample based on geometry information. For example, the first point may be matched to the third point based on a geometry distance metric. The third point may be a point in the current PC sample that is of the smallest geometry distance metric to the first point.

In some embodiments, the geometry distance metric of two points may be a difference between geometry information of the two points. For example, the geometry information may comprise Morton code value.

In some embodiments, information regarding whether to and/or how to apply the method may be indicated in the bitstream. For example, the information may be indicated in a frame, a tile, a slice, an octree, or the like.

In some embodiments, information regarding whether to and/or how to apply the method may be dependent on coded information. By way of example rather than limitation, the coded information may comprise a dimension, a color format, a color component, a slice type, a picture type, and/or the like.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a conversion between a current point cloud (PC) sample of the point cloud sequence and the bitstream is performed. An attribute inter prediction scheme is enabled for a set of levels in a first tree structure for spatial partition of the current PC sample, and the bitstream comprises a first indication indicating the number of the set of levels.

According to still further embodiments of the present disclosure, a method for storing a bitstream of a point cloud sequence is provided. In the method, a conversion between a current point cloud (PC) sample of the point cloud sequence and the bitstream is performed. An attribute inter prediction scheme is enabled for a set of levels in a first tree structure for spatial partition of the current PC sample, and the bitstream comprises a first indication indicating the number of the set of levels. Moreover, the bitstream is stored in a non-transitory computer-readable recording medium.

Implementations of the present disclosure can be described in view of the following clauses, the features of which can be combined in any reasonable manner.

Clause 1. A method for point cloud coding, comprising: performing a conversion between a current point cloud (PC) sample of a point cloud sequence and a bitstream of the point cloud sequence, wherein an attribute inter prediction scheme is enabled for a set of levels in a first tree structure for spatial partition of the current PC sample, and the bitstream comprises a first indication indicating the number of the set of levels.

Clause 2. The method of clause 1, wherein the first tree structure comprises a plurality of levels, and each of the plurality of levels corresponds to one depth in the first tree structure.

Clause 3. The method of any of clauses 1-2, wherein the set of levels comprises the first N levels in the first tree structure that are counted starting from a root node of the first tree structure, and N is equal to the number of the set of levels.

Clause 4. The method of any of clauses 1-2, wherein the set of levels comprises the last N levels in the first tree structure that are counted starting from a leaf node of the first tree structure, and N is equal to the number of the set of levels.

Clause 5. The method of any of clauses 1-4, wherein the number of the set of levels is a non-negative integer.

Clause 6. The method of any of clauses 1-5, wherein the number of the set of levels is predetermined, or the number of the set of levels is determined at an encoder for performing the conversion, or the number of the set of levels is determined at a decoder for performing the conversion, or the number of the set of levels is obtained at the decoder from the bitstream.

Clause 7. The method of any of clauses 1-6, wherein the number of the set of levels is coded with one of the following: a fixed-length coding, a unary coding, or a truncated unary coding.

Clause 8. The method of any of clauses 1-6, wherein the number of the set of levels is coded in a predictive way.

Clause 9. The method of any of clauses 1-8, wherein the bitstream further comprises a set of indications, each level in the first tree structure corresponds to at least one indication in the set of indications, and the at least one indication indicates whether the attribute inter prediction scheme is enabled for the corresponding level.

Clause 10. The method of clause 9, wherein the bitstream further comprises a set of indications corresponding to the set of levels for which the attribute inter prediction scheme is enabled, each of the set of indications comprises a depth value of a corresponding level.

Clause 11. The method of any of clauses 9-10, wherein the set of indications is determined based on one of the following: a rate optimization selection process, a distortion optimization selection process, or a rate-distortion optimization selection process.

Clause 12. The method of any of clauses 9-11, wherein the set of indications is predetermined, or the set of indications is determined at an encoder for performing the conversion, or the set of indications is determined at a decoder for performing the conversion, or the set of indications is obtained at the decoder from the bitstream.

Clause 13. The method of any of clauses 9-12, wherein the set of indications is coded with one of the following: a fixed-length coding, a unary coding, or a truncated unary coding.

Clause 14. The method of any of clauses 9-12, wherein the set of indications is coded in a predictive way.

Clause 15. The method of any of clauses 1-14, wherein a target prediction associated with attribute information of a current node in the current PC sample is determined based on a plurality of candidate predictions associated with the attribute information of the current node, wherein a first candidate prediction in the plurality of candidate predictions is determined based on the attribute inter prediction scheme, and a second candidate prediction in the plurality of candidate predictions is determined based on an attribute intra prediction scheme.

Clause 16. The method of clause 15, wherein each of the target prediction and the plurality of candidate predictions is a prediction of a coefficient for the attribute information of the current node, or each of the target prediction and the plurality of candidate predictions is a prediction of the attribute information of the current node.

Clause 17. The method of clause 16, wherein the coefficient is obtained by performing a region-adaptive hierarchical transform (RAHT) on the attribute information of the current node.

Clause 18. The method of any of clauses 16-17, wherein the coefficient is an alternating current (AC) coefficient or a direct current (DC) coefficient.

Clause 19. The method of any of clauses 16-18, wherein the current node comprises the current PC sample and is a root node of the first tree structure, or the current node comprises a part of the current PC sample and is a non-root node of the first tree structure.

Clause 20. The method of any of clauses 15-19, wherein the target prediction is determined based on an average of the plurality of candidate predictions.

Clause 21. The method of any of clauses 15-19, wherein the target prediction is determined based on a weighted average of the plurality of candidate predictions.

Clause 22. The method of clause 21, wherein weight values for determining the weighted average are predetermined, or the weight values are determined at an encoder for performing the conversion, or the weight values are determined at a decoder for performing the conversion, or the weight values are indicated in the bitstream.

Clause 23. The method of any of clauses 21-22, wherein weight values for determining the weighted average are coded with one of the following: a fixed-length coding, a unary coding, or a truncated unary coding.

Clause 24. The method of any of clauses 21-22, wherein weight values for determining the weighted average are coded in a predictive way.

Clause 25. The method of any of clauses 15-19, wherein one of the plurality of candidate predictions is selected to be the target prediction.

Clause 26. The method of clause 25, wherein the target prediction is selected from the plurality of candidate predictions based on a determining process.

Clause 27. The method of clause 26, wherein the determining process comprise one of the following: a rate optimization selection process, a distortion optimization selection process, or a rate-distortion optimization selection process.

Clause 28. The method of clause 11 or 27, wherein a distortion used in the distortion optimization selection process or the rate-distortion optimization selection process is determined based on a prediction residual or a reconstruction residual.

Clause 29. The method of any of clauses 26-28, wherein a result of the determining process is determined at an encoder for performing the conversion, or the result of the determining process is determined at a decoder for performing the conversion, or the result of the determining process is indicated in the bitstream.

Clause 30. The method of any of clauses 26-29, wherein a result of the determining process is coded with one of the following: a fixed-length coding, a unary coding, or a truncated unary coding.

Clause 31. The method of any of clauses 26-29, wherein a result of the determining process is coded in a predictive way.

Clause 32. The method of any of clauses 15-19, wherein the target prediction is determined based on a linear function of the plurality of candidate predictions, or the target prediction is determined based on a non-linear function of the plurality of candidate predictions.

Clause 33. The method of any of clauses 1-32, wherein for performing the attribute inter prediction scheme, a second tree structure for spatial partition of a reference PC sample for the current PC sample is determined and the same as the first tree structure.

Clause 34. The method of any of clauses 1-33, wherein a spatial partition scheme for the current PC sample is determined based on geometry information of the current PC sample, and the spatial partition scheme is performed from a leaf node level in the first tree structure to a root node level in the first tree structure.

Clause 35. The method of clause 34, wherein the spatial partition scheme is applied to the current PC sample and a reference PC sample for the current PC sample.

Clause 36. The method of any of clauses 34-35, wherein the spatial partition scheme is backward octree scan.

Clause 37. The method of any of clauses 34-36, wherein each node in a second tree structure for spatial partition of a reference PC sample for the current PC sample corresponds to a node in the first tree structure.

Clause 38. The method of clause 37, wherein a tree location of a node in the second tree structure is the same as a tree location of a corresponding node in the first tree structure.

Clause 39. The method of clause 37, wherein a Morton code value of a node in the second tree structure is the same as a Morton code value of a corresponding node in the first tree structure.

Clause 40. The method of any of clauses 37-39, wherein attribute information of a point in a node in the first tree structure is determined based on attribute information of a point in a corresponding node in the second tree structure.

Clause 41. The method of any of clauses 1-40, wherein a match process is performed to match a point in a reference PC sample for the current PC sample to a point in the current PC sample.

Clause 42. The method of clause 41, wherein the match process is performed before an RAHT and the attribute inter prediction scheme is performed.

Clause 43. The method of any of clauses 41-42, wherein the match process is applied on all points in the reference PC sample.

Clause 44. The method of any of clauses 41-42, wherein the match process is applied on a part of points in the reference PC sample.

Clause 45. The method of any of clauses 41-44, wherein if geometry metric of a first point in the reference PC sample is higher than a first threshold and lower than a second threshold that is higher than the first threshold, the match process is applied on the first point.

Clause 46. The method of clauses 45, wherein the geometry metric comprises a Morton code value.

Clause 47. The method of any of clauses 45-46, wherein the first threshold is determined based on the smallest geometry metric among geometry metrics of all points in the current PC sample.

Clause 48. The method of any of clauses 45-47, wherein the second threshold is determined based on the largest geometry metric among geometry metrics of all points in the current PC sample.

Clause 49. The method of any of clauses 41-44, wherein if a distance metric from a first point in the reference PC sample to a second point different from the first point is lower than a third threshold, the match process is applied on the first point.

Clause 50. The method of clause 49, wherein the second point is a point in the reference PC sample that is of the largest geometry metric among geometry metrics of a first set of points in the reference PC sample, the geometry metrics of the first set of points being smaller than the smallest geometry metric among geometry metrics of all points in the current PC sample.

Clause 51. The method of clause 49, wherein the second point is a point in the reference PC sample that is of the smallest geometry metric among geometry metrics of a second set of points in the reference PC sample, the geometry metrics of the second set of points being larger than the largest geometry metric among geometry metrics of all points in the current PC sample.

Clause 52. The method of any of clauses 50-51, wherein the geometry metric comprises Morton code value.

Clause 53. The method of any of clauses 49-52, wherein the distance metric from the first point to the second point is the number of points between the first point and the second point in Morton code value order.

Clause 54. The method of any of clauses 49-53, wherein the third threshold is predetermined, or the third threshold is indicated in the bitstream.

Clause 55. The method of any of clauses 49-54, wherein the third threshold is coded with one of the following: a fixed-length coding, a unary coding, or a truncated unary coding.

Clause 56. The method of any of clauses 49-54, wherein the third threshold is coded in a predictive way.

Clause 57. The method of any of clauses 41-56, wherein in the match process, a first point in the reference PC sample is matched to a third point in the current PC sample based on geometry information.

Clause 58. The method of any of clauses 41-56, wherein in the match process, a first point in the reference PC sample is matched to a third point in the current PC sample based on a geometry distance metric.

Clause 59. The method of clause 58, wherein the third point is a point in the current PC sample that is of the smallest geometry distance metric to the first point.

Clause 60. The method of any of clauses 58-59, wherein the geometry distance metric of two points is a difference between geometry information of the two points.

Clause 61. The method of clauses 60, wherein the geometry information comprises Morton code value.

Clause 62. The method of any of clauses 1-61, wherein a tree structure is an octree structure.

Clause 63. The method of any of clauses 1-62, wherein a PC sample is one of the following: a frame, a picture, a slice, a sub-frame, a sub-picture, a tile, or a segment.

Clause 64. The method of any of clauses 1-63, wherein information regarding whether to and/or how to apply the method is indicated in the bitstream.

Clause 65. The method of any of clauses 1-64, wherein information regarding whether to and/or how to apply the method is indicated in one of the following: a frame, a tile, a slice, or an octree.

Clause 66. The method of any of clauses 1-64, wherein information regarding whether to and/or how to apply the method is dependent on coded information.

Clause 67. The method of clause 65, wherein the coded information comprises at least one of the following: a dimension, a color format, a color component, a slice type, or a picture type.

Clause 68. The method of any of clauses 1-67, wherein the conversion includes encoding the current PC sample into the bitstream.

Clause 69. The method of any of clauses 1-67, wherein the conversion includes decoding the current PC sample from the bitstream.

Clause 70. An apparatus for point cloud coding comprising a processor and a non-transitory memory with instructions thereon, wherein the instructions upon execution by the processor, cause the processor to perform a method in accordance with any of clauses 1-69.

Clause 71. A non-transitory computer-readable storage medium storing instructions that cause a processor to perform a method in accordance with any of clauses 1-69.

Clause 72. A non-transitory computer-readable recording medium storing a bitstream of a point cloud sequence which is generated by a method performed by an apparatus for point cloud coding, wherein the method comprises: performing a conversion between a current point cloud (PC) sample of the point cloud sequence and the bitstream, wherein an attribute inter prediction scheme is enabled for a set of levels in a first tree structure for spatial partition of the current PC sample, and the bitstream comprises a first indication indicating the number of the set of levels.

Clause 73. A method for storing a bitstream of a point cloud sequence, comprising: performing a conversion between a current point cloud (PC) sample of the point cloud sequence and the bitstream, wherein an attribute inter prediction scheme is enabled for a set of levels in a first tree structure for spatial partition of the current PC sample, and the bitstream comprises a first indication indicating the number of the set of levels; and storing the bitstream in a non-transitory computer-readable recording medium.

### Example Device

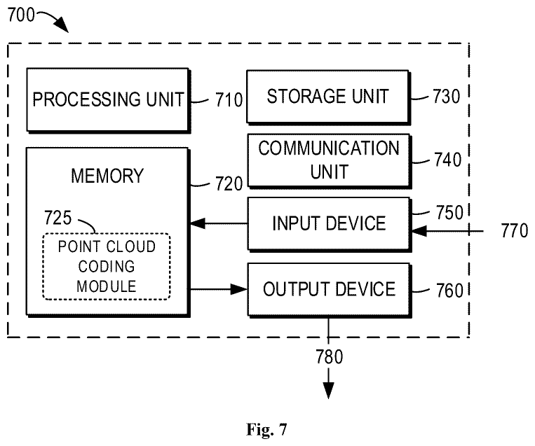

FIG. 7 illustrates a block diagram of a computing device 700 in which various embodiments of the present disclosure can be implemented. The computing device 700 may be implemented as or included in the source device 110 (or the GPCC encoder 116 or 200) or the destination device 120 (or the GPCC decoder 126 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement point cloud encoding/decoding in embodiments of the present disclosure. The memory 720 may include one or more point cloud coding modules 725 having one or more program instructions. These modules are accessible and executable by the processing unit 710 to perform the functionalities of the various embodiments described herein.

In the example embodiments of performing point cloud encoding, the input device 750 may receive point cloud data as an input 770 to be encoded. The point cloud data may be processed, for example, by the point cloud coding module 725, to generate an encoded bitstream. The encoded bitstream may be provided via the output device 760 as an output 780.

In the example embodiments of performing point cloud decoding, the input device 750 may receive an encoded bitstream as the input 770. The encoded bitstream may be processed, for example, by the point cloud coding module 725, to generate decoded point cloud data. The decoded point cloud data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
performing a conversion between a current point cloud (PC) sample of a point cloud sequence and a bitstream of the point cloud sequence, wherein an attribute inter prediction scheme is enabled for a set of levels in a first tree structure for spatial partition of the current PC sample, and the bitstream comprises a first indication indicating the number of the set of levels.

2. The method of claim 1, wherein the set of levels comprises the first N levels in the first tree structure that are counted starting from a root node of the first tree structure, and N is equal to the number of the set of levels.

3. The method of claim 1, wherein the bitstream further comprises a set of indications, each level in the first tree structure corresponds to at least one indication in the set of indications, and the at least one indication indicates whether the attribute inter prediction scheme is enabled for the corresponding level.

4. The method of claim 3, wherein the at least one indication comprises a depth value of the corresponding level.

5. The method of claim 1, wherein a target prediction associated with attribute information of a current node in the current PC sample is determined based on a plurality of candidate predictions associated with the attribute information of the current node, wherein a first candidate prediction in the plurality of candidate predictions is determined based on the attribute inter prediction scheme, and a second candidate prediction in the plurality of candidate predictions is determined based on an attribute intra prediction scheme.

6. The method of claim 5, wherein each of the target prediction and the plurality of candidate predictions is a prediction of a coefficient for the attribute information of the current node.

7. The method of claim 6, wherein the coefficient is an alternating current (AC) coefficient or a direct current (DC) coefficient.

8. The method of claim 5, wherein the target prediction is determined based on a weighted average of the plurality of candidate predictions.

9. The method of claim 8, wherein weight values for determining the weighted average are allowed to be indicated in the bitstream, and if the weight values are not indicated in the bitstream, the weight values are set to predetermined values.

10. The method of claim 5, wherein the target prediction is selected from the plurality of candidate predictions based on a determining process.

11. The method of claim 10, wherein the result of the determining process is determined at a decoder for performing the conversion, or
the result of the determining process is indicated in the bitstream.

12. The method of claim 1, wherein for performing the attribute inter prediction scheme, a second tree structure for spatial partition of a reference PC sample for the current PC sample is determined based on a same octree scan as the first tree structure.

13. The method of claim 12, wherein each node in the second tree structure corresponds to a node in the first tree structure.

14. The method of claim 13, wherein a tree location of a node in the second tree structure is the same as a tree location of a corresponding node in the first tree structure.

15. The method of claim 1, wherein a PC sample is one of the following:
a frame,
a picture,
a slice,
a sub-frame,
a sub-picture,
a tile, or
a segment.

16. The method of claim 1, wherein the conversion includes encoding the current PC sample into the bitstream.

17. The method of claim 1, wherein the conversion includes decoding the current PC sample from the bitstream.

18. An apparatus for point cloud coding comprising a processor and a non-transitory memory with instructions thereon, wherein the instructions upon execution by the processor, cause the processor to perform acts comprising:
performing a conversion between a current point cloud (PC) sample of a point cloud sequence and a bitstream of the point cloud sequence, wherein an attribute inter prediction scheme is enabled for a set of levels in a first tree structure for spatial partition of the current PC sample, and the bitstream comprises a first indication indicating the number of the set of levels.

19. A non-transitory computer-readable storage medium storing instructions that cause a processor to perform acts comprising:
performing a conversion between a current point cloud (PC) sample of a point cloud sequence and a bitstream of the point cloud sequence, wherein an attribute inter prediction scheme is enabled for a set of levels in a first tree structure for spatial partition of the current PC sample, and the bitstream comprises a first indication indicating the number of the set of levels.

20. A non-transitory computer-readable recording medium storing a bitstream of a point cloud sequence which is generated by a method performed by an apparatus for point cloud coding, wherein the method comprises:
performing a conversion between a current point cloud (PC) sample of the point cloud sequence and the bitstream, wherein an attribute inter prediction scheme is enabled for a set of levels in a first tree structure for spatial partition of the current PC sample, and the bitstream comprises a first indication indicating the number of the set of levels.
